(19) United States
(12) Patent Application Publication
(10) Pub. No.: US 2008/0081641 A1
(43) Pub. Date: Apr. 3, 2008

(54) Method and system for a consumer traffic monitoring and notification system

(75) Inventors: Cyrus W. Smith, Marietta, GA (US); Todd L. Jackson, Decatur, GA (US)

Correspondence Address: KING & SPALDING LLP, 1180 PEACHTREE STREET, ATLANTA, GA, 30309-3521, US

(73) Assignee: AirSage, Inc.

(21) Appl. No.: 11/903,140

(22) Filed: Sep. 20, 2007

Related U.S. Application Data
(60) Provisional application No. 60/846,241, filed on Sep. 21, 2006.

(51) Int. Cl. H04M 1/00

(52) U.S. Cl. 455/456.3

(57) ABSTRACT

Actively providing consumer traffic monitoring and notification. The present invention determines a user's location, based on the location of the user's cellular phone. The present invention may determine specific destinations that the user often travels to and routes that the user takes between destinations. The present invention may inform the user of traffic conditions based on information received or developed by the system. These notifications may be actively sent to the user based on the user's location or the user may query the system for information. The system may automatically deliver information to the user based on specific locations of the user, such as arriving at an airport from another city.

### STATEMENT OF RELATED PATENT APPLICATIONS

This non-provisional patent application claims priority under 35 U.S.C. § 119 to U.S. Provisional Patent Application No. 60/846,241, titled Method and System for a Consumer Traffic Monitoring and Notification System, filed Sep. 21, 2006. This provisional application is hereby fully incorporated herein by reference.

### FIELD OF THE INVENTION

This invention relates to systems and methods for using wireless telephony network data for monitoring a user's travel and notifying the user of travel-related information. More particularly, this invention relates to determining a user's locations, destinations, and travel routes and notifying the user of traffic information related to those locations, destinations, and routes.

### BACKGROUND OF THE INVENTION

Traffic congestion has grown substantially over the past 20 years. Traffic congestion is worst in large cities, but urban areas of all sizes have seen an increase in congestion over this time period. In addition to “rush hour,” congestion results from bottlenecks, traffic incidents, weather conditions, road work, traffic control devices, and special events and holidays. Also, congestion on one roadway can impact congestion on other roadways. In some cases, these other roadways represent alternative routes and, in other cases, these other roadways are feeder routes to the congested roadway.

To help inform travelers of traffic congestion, cities have begun to provide systems that provide travelers with information on traffic conditions. However, most existing systems are limited to monitoring traffic on major freeways, where physical sensors have been installed. This limitation leaves many travelers without any information on arterials or side streets, where a significant portion of driving occurs.

Some systems can determine traffic conditions along specific travel routes. However, these systems typically do so for routes that have been pre-configured by the traveler or by the system. When the traveler takes an alternate route or a spontaneous trip, the system will not be able to provide any guidance.

Also over the last 20 years, cellular phone use has grown tremendously. In 2006, 76% of the population in the U.S. subscribe to cellular phone service, up from 13% in 1995, according to the International Association for the Wireless Telecommunications Industry. This growth in cellular phone use, coupled with the increasing traffic congestion problem, has led to innovative systems for assessing traffic situations based on analyzing cellular phone use associated with vehicles. Although these systems have advantages over physical sensors or other systems, existing solutions are not location-aware, that is, aware of the location of a specific cellular phone user, and these systems send notifications based on time of day or when other user-defined criteria are met. In most cases, users care about traffic conditions that will affect them directly only. If a user is out of town on a business trip, for example, the user does not care about congestion that would affect the user's normal commute.

In view of the foregoing, there is a need for a system that leverages cellular-based traffic information to provide users with specific traffic information related to that user's location, destination, and routes of travel. The present invention provides systems and methods that collect and process information from wireless telephony for monitoring a user's travel and notifying the user of travel-related information.

### SUMMARY OF THE INVENTION

The present invention provides systems and methods that collect and process information from wireless telephony for monitoring a user's travel and notifying the user of travel-related information. In one aspect of the invention, a system for providing consumer traffic monitoring and notification is provided. The system includes a data extraction module operable to extract signal data from a wireless telephony network comprising location information for a mobile station; a data analysis node, logically connected to the data extraction module and operable to identify a location associated with the mobile station, receive traffic-related information, and automatically send a notification in response to the location of the mobile station and the received traffic-related information; a destination identification module logically connected to the data analysis node and operable to determine a destination associated with the mobile station based on identified locations for the mobile station; and a route identification module, logically connected to the destination identification module and operable to determine one or more routes between the mobile station and one or more destinations.

In another aspect of the present invention, a method for providing consumer traffic monitoring and notification is provided. Steps of this method include: a) determining a plurality of locations of a mobile station, based on signal data from a wireless telephony network; b) determining a plurality of destinations for the mobile station based on the determined plurality of locations; c) determining a route between one of the plurality of locations of the mobile station and any of the plurality of the determined destinations for the mobile station; d) receiving traffic-related information; and e) automatically sending a notification in response to the received traffic-related information; wherein the notification comprises traffic conditions associated with the route.

In another aspect of the present invention, a method for providing consumer traffic monitoring and notification is provided. The steps of this method include: a) determining a location of a mobile station; b) determining whether the location of the mobile station corresponds to a pre-existing location; c) receiving traffic-related information; and d) automatically sending a notification in response to the received traffic-related information when the location of the mobile station corresponds to the pre-existing location; wherein the notification comprises traffic conditions associated with the pre-existing location

In yet another aspect of the invention, a system for providing consumer traffic monitoring and notification is provided. The system includes system for providing consumer traffic monitoring and notification includes: a data extraction module operable to extract signal data from a wireless telephony network comprising location information for a mobile station; and a data analysis node, logically connected to the data extraction module and operable to identify a location associated with the mobile station, receive traffic-related information, and automatically send a notification in response to the location of the mobile station and the received traffic-related information.

The aspects of the present invention may be more clearly understood and appreciated from a review of the following detailed description of the disclosed embodiments and by reference to the drawings and claims.

### BRIEF DESCRIPTION OF THE DRAWINGS

FIG. 1 depicts an operating environment in relation to a wireless telephony network in accordance with an exemplary embodiment of the present invention.

FIG. 2 presents a block diagram showing components of a consumer traffic monitoring and notification system in accordance with an exemplary embodiment of the present invention.

FIG. 3 depicts a block diagram of a data extraction module within a consumer traffic monitoring and notification system in accordance with an exemplary embodiment of the present invention.

FIG. 4a presents a block diagram showing components of a consumer traffic monitoring and notification system in accordance with an exemplary embodiment of the present invention.

FIG. 4b presents a block diagram showing components of a consumer traffic monitoring and notification system in accordance with an alternative exemplary embodiment of the present invention.

FIG. 4c presents a block diagram showing components of a consumer traffic monitoring and notification system in accordance with an alternative exemplary embodiment of the present invention.

FIG. 4d presents a block diagram showing components of a consumer traffic monitoring and notification system in accordance with an alternative exemplary embodiment of the present invention.

FIG. 5 depicts a block diagram of a data input and processing module within a consumer traffic monitoring and notification system in accordance with an exemplary embodiment of the present invention.

FIG. 6 depicts a block diagram of a data analysis node within a consumer traffic monitoring and notification system in accordance with an exemplary embodiment of the present invention.

FIG. 7 presents a process flow diagram for a Privacy Module in accordance with an exemplary embodiment of the present invention.

FIG. 8 presents an overall process flow diagram for consumer traffic monitoring and notification in accordance with an exemplary embodiment of the present invention.

FIG. 9 presents a process flow diagram for tracking locations of a cellular phone user in accordance with an exemplary embodiment of the present invention.

FIG. 10 presents a process flow diagram for identifying travel destinations for a user in accordance with an exemplary embodiment of the present invention.

FIG. 11 presents a process flow diagram for identifying travel routes for a user in accordance with an exemplary embodiment of the present invention.

FIG. 12 presents a process flow diagram for notifying a user of traffic information in accordance with an exemplary embodiment of the present invention.

FIG. 13 presents a process flow diagram for notifying a user of traffic information based on the user being located at an airport in accordance with an exemplary embodiment of the present invention.

### DETAILED DESCRIPTION OF THE EXEMPLARY EMBODIMENTS

Exemplary embodiments of the present invention provide systems and methods that collect and process information from wireless telephony for monitoring a user's travel and notifying the user of travel-related information. The present invention supports systems and methods for actively providing consumer traffic monitoring and notification. The present invention determines a user's location, based on the location of the user's cellular phone. The present invention may determine specific destinations that the user often travels to and from and routes that the user takes between destinations. The present invention may inform the user of traffic conditions based on information received by or developed by the system. These notifications may be actively sent to the user based on the user's location or the user may query the system for information. The system may automatically deliver information to the user based on specific locations of the user, such as arriving at an airport from another city.

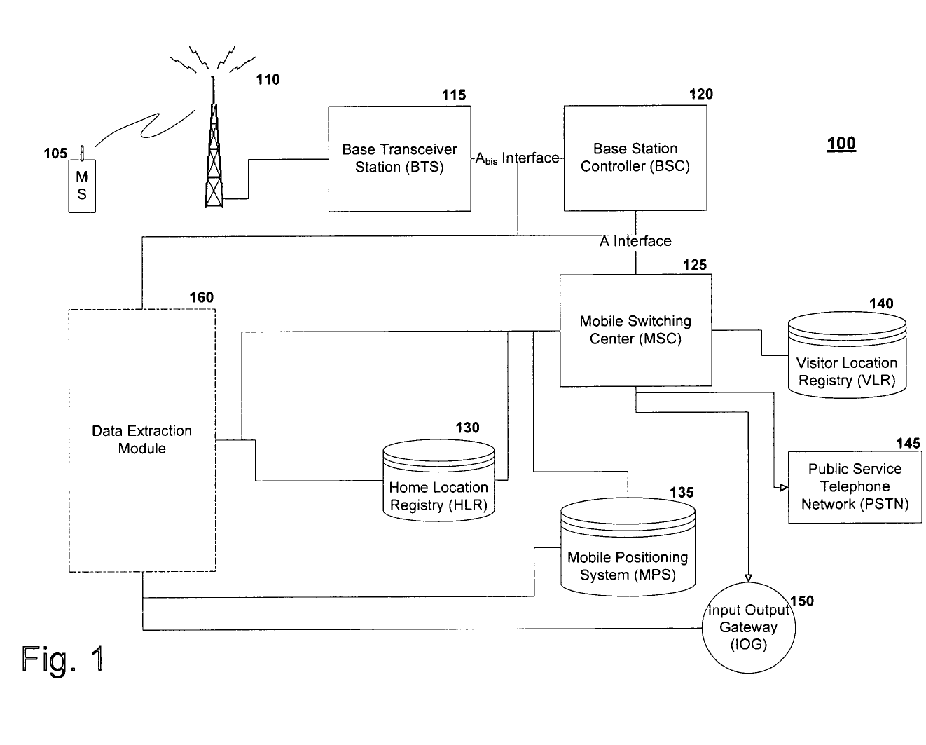

FIG. 1 depicts an operating environment in relation to a wireless telephony network 100 in accordance with an exemplary embodiment of the present invention. Referring to FIG. 1, mobile station (MS) 105 transmits signals to and receives signals from a radiofrequency transmission tower 110 while within a geographic cell covered by the tower. These cells vary in size based on anticipated signal volume. A Base Transceiver System (BTS) 115 is used to provide service to mobile subscribers within its cell. Several Base Transceiver Systems 115 are combined and controlled by a Base Station Controller (BSC) 120 through a connection called the A_{bis} Interface. A Data Extraction Module 160 can interface with the A_{bis} Interface line.

A Mobile Switching Center (MSC) 125 does the complex task of coordinating all the Base Station Controllers, through the A_{bis} Interface connection, keeping track of all active mobile subscribers using the Visitor Location Register (VLR) 140, maintaining the home subscriber records using the Home Location Register (HLR) 130, and connecting the mobile subscribers to the Public Service Telephone Network (PSTN) 145.

The location of a mobile station 105 can be determined by embedding a GPS chip in the mobile station 105, or by measuring certain signaling characteristics between the mobile station 105 and the BTS 115. In either scenario, the process of locating a mobile station 105 is managed with a Mobile Positioning System (MPS) 135. The MPS 135 uses the same network resources that are used to manage and process calls, which makes its availability somewhat limited.

The Input Output Gateway (IOG) 150 processes call detail records (CDRs) to facilitate such actions as mobile subscriber billing. The IOG 150 receives call-related data from the MSC 125 and can interface with the Data Extraction Module 160.

The Data Extraction Module 160 may receive data from a variety of locations in the wireless network. These locations include the BSC 120 and its interface, through the A_{bis} Interface, with the BTS 115, MSC 125, the HLR 130, and the MPS 135. The Data Extraction Module 160 can use data from any network element that contains at a minimum the mobile station identifier number, cell ID, and a time stamp. Some of the more common data sources are discussed below. One of ordinary skill in the art would appreciate that some or all of the functions of the Data Extraction Module 160 could be conducted behind the “firewall” of the wireless telephony network. Alternatively, some or all of the data extraction operations could be carried out by one or more systems outside of the wireless telephony network. For example, a vendor could operate a system that extracts information from the IOG 150.

CDRs may be requested from billing distribution centers or the distribution centers may autonomously send the records via file transfer protocol (FTP). Alternatively the CDRs may be extracted as they are routinely passed from the IOG 150 to a billing gateway, possibly utilizing a router that duplicates the packets. The specific method used will depend on the equipment and preferences of the wireless service provider.

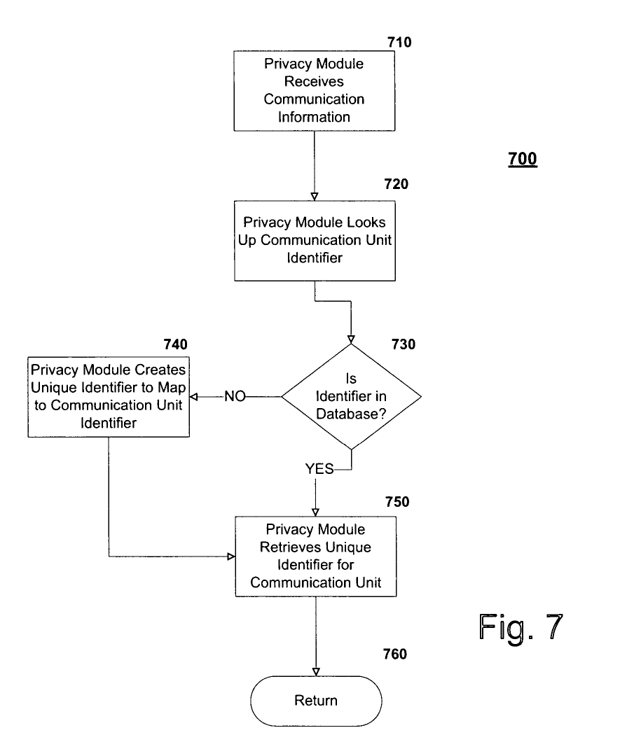

Handover and Registration messages may be obtained by monitoring the proprietary or standard A-interface signaling between the MSC 125 and the BSCs 120 that it controls. The Data Extraction Module 160 may monitor that signaling directly or it may obtain signaling information from a signal monitoring system such as a protocol analyzer. In the latter case the signaling information may already be filtered to remove extraneous information. See the discussion in conjunction with FIG. 7, below, of the privacy process for an exemplary embodiment of the present invention, which removes information that may identify the user of a specific mobile station 105. Alternatively, these messages may be extracted from a Base Station Manager that continuously monitors message streams on the BTS 115.

The inherent nature of cellular technology requires frequent data communications between the mobile station 105 and the Wireless Telephony Network 100. The approximate location of the mobile station 105 is one of the data elements transmitted from the mobile station 105 to the network 100. This “location awareness” is necessary to ensure that calls can be processed without delay or interruption and support enhanced 911 initiatives. Other data elements collected by the wireless telephony network 100 include the mobile device identification number and, if a call is involved, the calling or called number.

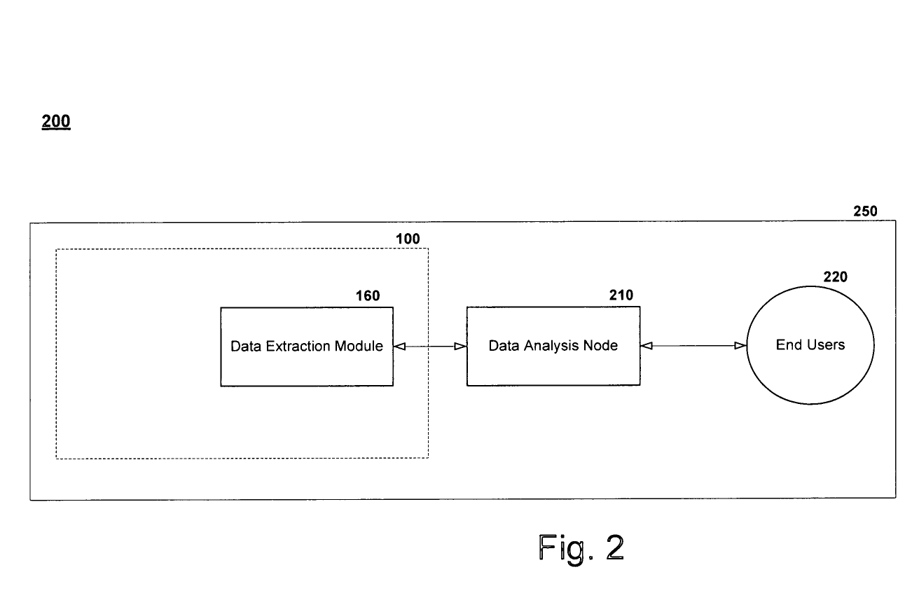

FIG. 2 presents a block diagram 200 showing components of a consumer traffic monitoring and notification system 250 in accordance with an exemplary embodiment of the present invention. Referring to FIGS. 1 and 2, the Data Extraction Module 160 is depicted as a component of the Wireless Telephony Network 100. One of ordinary skill in the art would appreciate that the Data Extraction Module 160 may be operated by a wireless network carrier or operated separately from the Wireless Telephony Network 100. In one example, the Data Extraction Module's 160 connection with the Wireless Telephony Network 100 would consist of data communications links and otherwise operate outside the network. In another example, another party (that is, an operator other than the wireless carrier) would operate the Data Extraction Module 160 within the Wireless Telephony Network 100. In yet another example, the wireless carrier may operate the Data Extraction Module 160.

The Data Extraction Module 160 extracts and manipulates data from the Wireless Telephony Network 100. The Data Extraction Module 160 is connected to a Data Analysis Node 210 such that they can convey data or instructions to one another. This connection may be any type of data connection, such as a local area network, a wide area network, or some other data communications connection. The Data Analysis Node 210 operates on the data extracted by the Data Extraction Module 160 to support consumer traffic monitoring and notification. The Data Analysis Node 210 is also connected, again by any type of data connection, to End Users 220. These connections may be through a cellular phone, such as by short message service (SMS), multimedia message service (MMS), wireless application protocol (WAP) push, or voice, or by other connections including computer networks such as the Internet or by land-line telephone. These End Users 220 represent the ultimate users of the analyses generated by the Data Analysis Node 210 and may also supply parameters used in analyses performed by the Data Analysis Node 210. These End Users 220 are also referred to herein as subscribers, that is, individuals that subscribe to a consumer traffic monitoring and notification service.

The exemplary Data Extraction Module 160 and the Data Analysis Node 220 provide two general functions. The Data Extraction Module 160 interfaces with information sources to receive information from those sources. This receipt of information may be continuous, in the sense that the information source supplies information to the Data Extraction Module 160 at regular intervals or as available. This receipt may be initiated by the information source, which may push the information to the Data Extraction Module 160. Other information my be received by the Data Extraction Module 160 based on requests from the Data Extraction Module 160 to the information source.

The Data Analysis Node 220 processes the information received by the Data Extraction Module 160 to support the needs of the End Users 220. This processing may trigger additional information needs, such that the Data Analysis Node 220 requests the information from specific information sources through the Data Extraction Module 160.

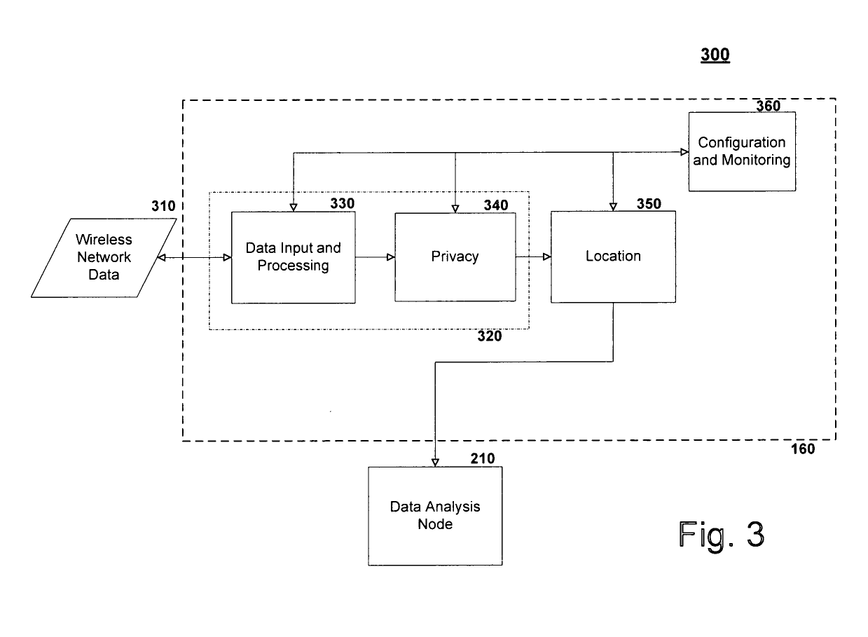

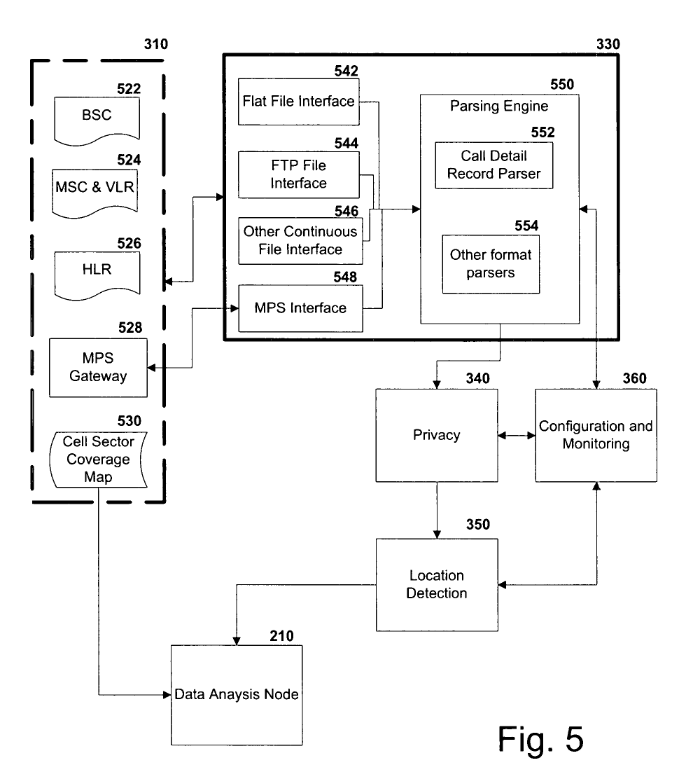

FIG. 3 depicts a block diagram 300 of a data extraction module within a consumer traffic monitoring and notification system in accordance with an exemplary embodiment of the present invention. Referring to FIGS. 1, 2 and 3, a Wireless Network Data component 310 is communicated to the Data Extraction Module 160. Specifically, in this exemplary embodiment, the Wireless Network Data 310 communicates with a Data Input and Processing Module 330. The Data Input and Processing Module 330 and a Privacy Module 340 are components of a Processor Module 320. The operations of the Data Input and Processing Module 330 are discussed in greater detail below, in connection with FIG. 5. Similarly, the operations of the Privacy Module 340 are discussed in greater detail in connection with FIG. 7, below.

The Processor Module 320 connects to a Location Module 350. The Location Module 350 generates location data associated with mobile stations 105. The Location Module 350 is linked to the Data Analysis Node 210. The Data Analysis Node 210 can access the Location Module 350 to receive location information, or other information, associated with one or more mobile stations 105.

The components of the Data Extraction Module 160, can be controlled by a Configuration and Monitoring Module 360. The Configuration and Monitoring Module 360 monitors the performance of the Data Extraction Module 160 and sets system operating parameters.

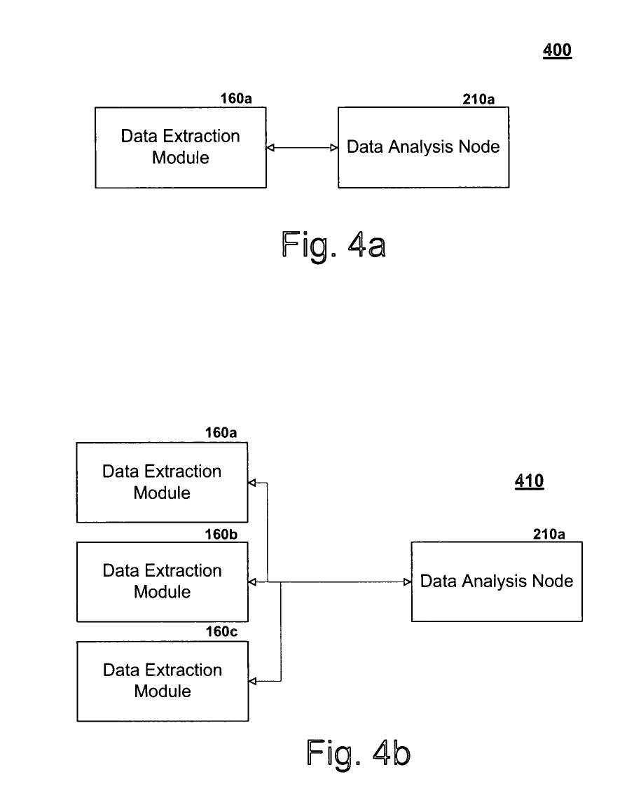

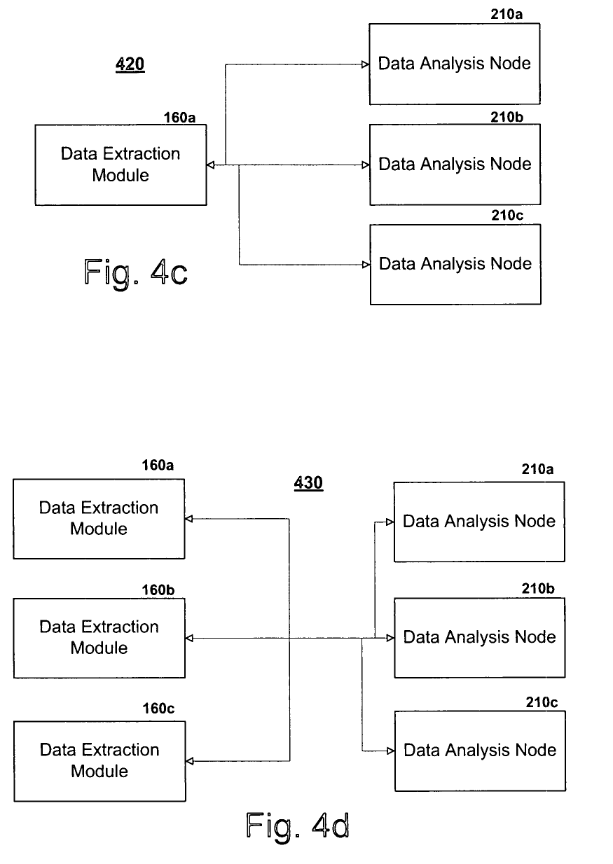

FIG. 4a presents a block diagram 400 showing components of a consumer traffic monitoring and notification system in accordance with an exemplary embodiment of the present invention. Referring to FIG. 4a, the block diagram 400 depicts a single Data Extraction Module 160a interacting with a single Data Analysis Node 210a.

FIG. 4b presents a block diagram 410 showing components of a consumer traffic monitoring and notification system in accordance with an alternative exemplary embodiment of the present invention. Referring to FIG. 4b, the block diagram 410 depicts multiple Data Extraction Modules 160a, 160b, 160c interacting with a single Data Analysis Node 210a. One of ordinary skill in the art would appreciate that any number of Data Extraction Modules 160 could interact with a single Data Analysis Node 210. For example, wireless telephony networks for a variety of wireless carriers could each have a Data Extraction Module 160 associated with each individual network. The data extracted by these Data Extraction Modules 160 could all be accessed and operated on by a single Data Analysis Node 210.

FIG. 4c presents a block diagram 420 showing components of a consumer traffic monitoring and notification system in accordance with an alternative exemplary embodiment of the present invention. Referring to FIG. 4c, the block diagram 420 depicts a single Data Extraction Modules 160a interacting with multiple Data Analysis Nodes 210a, 210b, 210c. One of ordinary skill in the art would appreciate that any number of Data Analysis Nodes 210 could interact with a single Data Extraction Module 160. For example, individual communities or individual traffic planning and engineering applications could have a dedicated Data Analysis Node 210, each linked to a common Data Extraction Module 160.

FIG. 4d presents a block diagram 430 showing components a consumer traffic monitoring and notification system in accordance with an alternative exemplary embodiment of the present invention. Referring to FIG. 4d, the block diagram 430 depicts a multiple Data Extraction Modules 160a, 160b, 160c interacting with multiple Data Analysis Nodes 210a, 210b, 210c. One of ordinary skill in the art would appreciate that any number of Data Analysis Nodes 210 could interact with any number of Data Extraction Module 160. For example, multiple individual consumer traffic monitoring and notification systems could each have a dedicated Data Analysis Node 210, each linked to multiple Data Extraction Module 160, such as one for each local wireless network carrier.

FIG. 5 depicts a block diagram 500 of a data input and processing module within a consumer traffic monitoring and notification system in accordance with an exemplary embodiment of the present invention. Referring to FIG. 5, a Data Input and Processing module 330 exchanges data with a Wireless Network Data component 310. A Data Input and Processing Module 330 includes file interfaces. These interfaces may be specific for a certain file type. In the exemplary embodiment depicted in FIG. 5, a Data Input and Processing Module 330 includes a Flat File Interface 542 and an FTP File Interface 544. These interfaces can poll the Wireless Network Data component 310, each interface polling the network component that contains the specific file type, data files on a local storage drive (flat files) and files at an FTP server (FTP files) in this exemplary embodiment.

Additionally, the Wireless Network Data component 310 may send a continuous stream of data to an Other Continuous File Interface 546, i.e., a Data Input and Processing Module 330 does not need to poll this data source. These data are taken from a BSC data store 522, MSC and VLR data store 524, and HLR data store 526 and may include call detail records, handover messages, and registration messages. One skilled in the art would appreciate that a Data Input and Processing Module 330 can be configured to collect information in whatever form the Wireless Network Data 310 generates.

In the exemplary embodiment, a Data Input and Processing Module 330 is also capable of receiving positioning data from the Wireless Network Data component 310 that include a mobile positioning system. An MPS Interface 548 interacts directly with an MPS Gateway 528 to request and receive specific MPS data. Also, the Data Analysis Node 210 can access data in concerning cell area coverage from a Cell Sector Coverage Map 530.

The file interfaces in a Data Input and Processing Module 330 send the data to a working directory. Files in the working directory cause events to be generated and sent to a Parsing Engine 550 for processing. The message contains the file name of the data file to be parsed. From this name, the most appropriate parser syntax is selected and the file is parsed. The program directory for the exemplary embodiment of the present invention contains a parser's subdirectory. Jar files containing parsers are placed in this directory. The name of the jar file must match a class name in the jar file and that class must implement the parser interface. Once implemented, the parser converts the extracted data into a format that can be used by the Privacy Module 340 and Location Detection Module 350. When the processing of the file is complete, the file is moved to a processed directory. Upon startup of the Data Input and Processing Module 330, all the files in the processed directory may be purged if they are older than a specified number of days. The specific operating parameters, such as how and when to store and delete data files, is controlled by the Configuration and Monitoring Module 360.

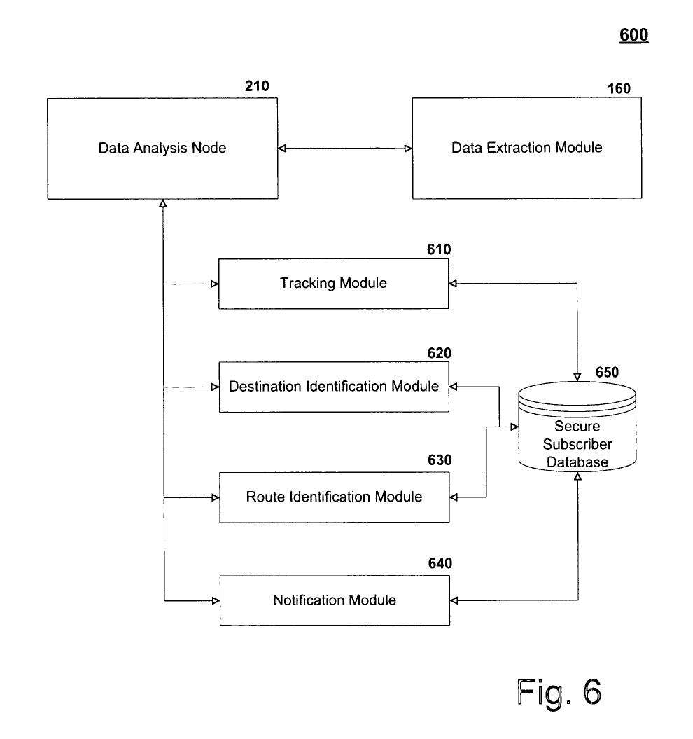

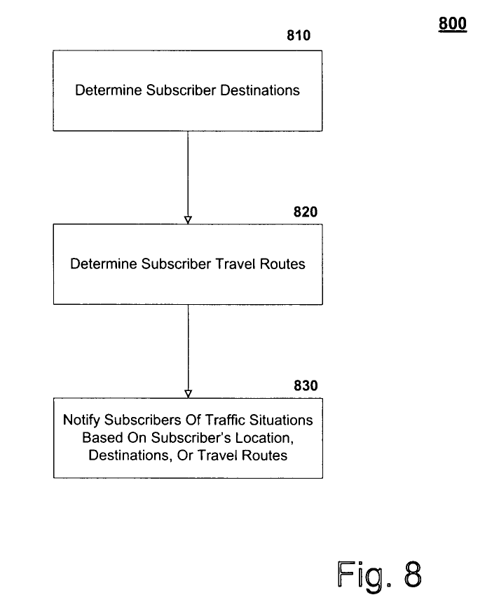

FIG. 6 depicts a block diagram of a data analysis node within a consumer traffic monitoring and notification system in accordance with an exemplary embodiment of the present invention. Referring to FIG. 6, the Data Analysis Node 210 interacts with a Data Extraction Module 160. The Data Analysis Node 210 includes four modules: a Tracking Module 610, a Destination Identification Module 620, a Route Identification Module 630, and a Notification Module 640. Exemplary operations of these four modules are discussed in greater detail below, in connection with FIGS. 8-13. The Data Analysis Node 210 also includes a Secure Subscriber Database 650. This database includes location, destination, and route data for subscribers. One reason for the secure nature of the database is that subscriber-identifying information, such as a mobile directory number (MDN), mobile station identifier (MSID), electronic serial number (ESN), or other personal information, including billing information and destination and travel route information.

Although in this exemplary embodiment the Tracking Module 610 is depicted as part of the Data Analysis Node 210, one of ordinary skill in the art would appreciate that the Tracking Module 610 could be incorporated in the Data Extraction Module 160, where it interacts with the Location Module 350 (see FIG. 3).

FIG. 7 presents a process flow diagram for a Privacy Module in accordance with an exemplary embodiment of the present invention. Referring to FIGS. 3 and 7, at step 710, the Privacy Module 340 receives communication information. At step 720, the Privacy Module 340 looks up a Communication Unit Identifier associated with the communications information in a database. This identifier may be the serial number or phone number of a mobile station and is also referred to as customer identifying information or subscriber information. The database includes all Communication Unit Identifiers processed by the Privacy Module 340. This database may be purged periodically, such as when a record is more than 24 hours old, to provide an extra measure of privacy. Although these data may be regularly purged, any resulting anonymous location records may be maintained for a long time to support ongoing transportation planning and engineering.

At step 730, the Privacy Module 340 determines if the Communication Unit Identifier is in the database. If the result of this determination is “NO,” then the Privacy Module 340 creates, at step 740, a unique identifier to map to the Communication Unit Identifier and both identifiers are stored in Privacy Module 340 database. This unique identifier could be a serial number, the results of an encryption algorithm, or other process for mapping a unique identifier with the Communication Unit Identifier. If the result of this determination is “YES,” or after step 740 is complete, the Privacy Module 340 retrieves, at step 750, the unique identifier for the communications unit. The further processing of the information uses the unique identifier rather than the personal identifying information. The Privacy Module 340 then moves to step 760, where it returns to the process that invoked the Privacy Module 340.

One of ordinary skill in the art would appreciate that the Privacy Module 340 operations could take place within a Wireless Telephony Network 100 (See FIG. 1) firewall or outside the firewall. Operations of the Privacy Module 340 could be conducted by the wireless network carrier, a third party vendor, or conducted by the party operating the Data Extraction Module 160 or Data Analysis Node 210. Additionally, although a separate Privacy Module 340 database has been discussed, one of ordinary skill in the art would appreciate that a single database structure may be used to support all data storage for the system.

In some cases, the information source may apply it own processes to mask personal identifying information. For example, a Wireless Telephony Network 100 may mask personal identifying information prior to conveying the information to the Data Extraction Module 160, such as by having a system that strips this information behind the network's firewall. Alternatively, the data source could contract with a separate data aggregator that supplies the information to the Data Extraction Module 160, after personal identifying information was removed. In yet another alternative, all data may be maintained behind a carrier's firewall, such that the privacy module is not necessary.

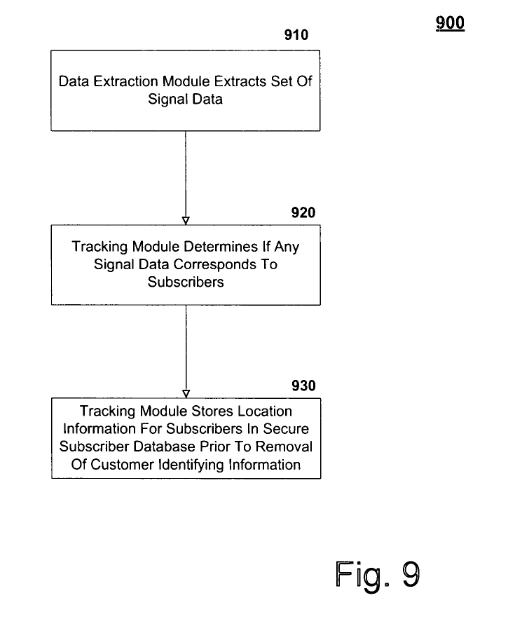

FIG. 8 presents an overall process flow diagram 800 for consumer traffic monitoring and notification in accordance with an exemplary embodiment of the present invention. Referring to FIGS. 2 and 8, at step 810, the consumer traffic monitoring and notification system 250 determines subscriber Destinations. These Destinations represent common destinations for a subscriber, that is, locations where the subscriber frequently travels to and from. Examples of Destinations include “Home,” “Work,” “Johnny's School,” “Gym,” “Soccer Field,” and so on. Destinations may be tailored by each individual subscriber. The purpose of these Destinations is for the consumer traffic monitoring and notification system 250 to provide the subscriber with traffic information related to these Destinations. This step is discussed in greater detail in connection with FIGS. 8 and 9.

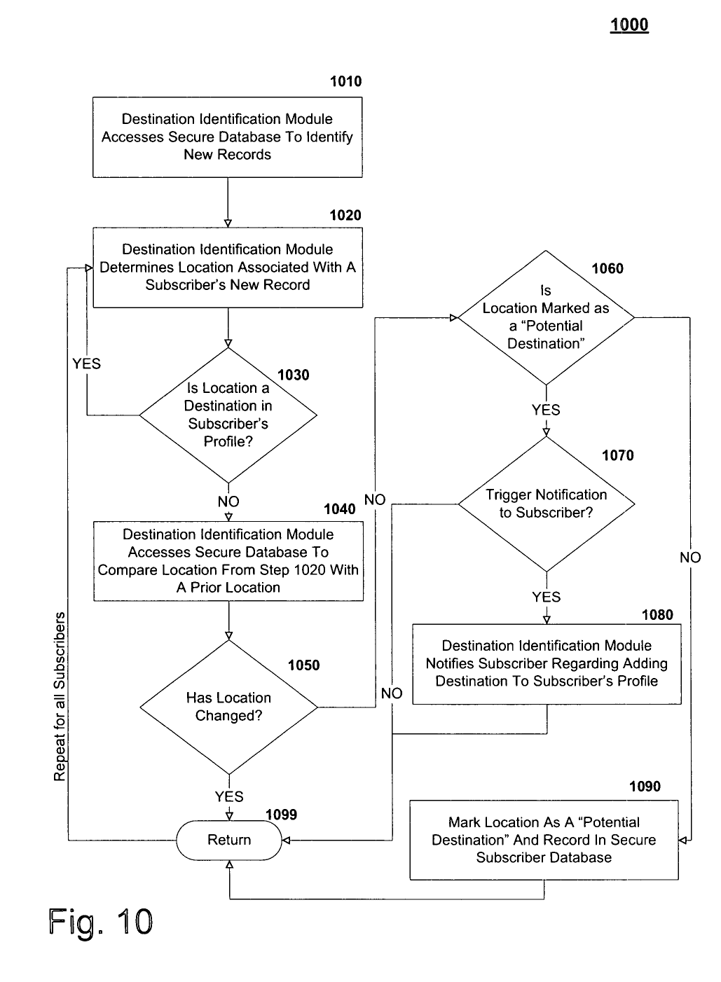

At step 820, the consumer traffic monitoring and notification system 250 determines subscriber routes. These routes would be the routes taken by the subscriber between Destinations. A pair of Destinations may have multiple routes associated with it, reflecting the fact that the subscriber can take alternate routes between the Destinations. For example, the subscriber may take an interstate highway for most of a trip between “Home” and the “Soccer Field.” The subscriber might alternatively take a U.S. highway that parallels the interstate highway. The consumer traffic monitoring and notification system 250 would store both of these typical routes between Destinations. The determination of the routes is based on actual travel along the route by the subscriber. This step is discussed in greater detail below, in connection with FIG. 10.

At step 830, the consumer traffic monitoring and notification system 250 notifies subscribers of traffic situations based on a subscriber's location, Destinations, or travel routes. For example, the consumer traffic monitoring and notification system 250 may notify a subscriber about a traffic incident along a route normally traveled by the subscriber, such as a route between “Work” and “Home.” Also, the consumer traffic monitoring and notification system 250 may notify the subscriber of traffic incidents near the subscriber's current location. For example, the consumer traffic monitoring and notification system 250 may notify the subscriber of traffic congestion around a sports venue if the subscriber is within a specific distance of the venue.

Also, if a subscriber has more than one route between a pair of Destinations, the subscriber can query the system to see which route has the shortest travel time. The subscriber query would contain an identifier for the desired Destination. Upon receiving the subscriber's request, the consumer traffic monitoring and notification system 250 will calculate travel time on each route stored in the system, and return the quickest route, or if desired, travel times on all of the routes so that the subscriber can choose the route to take.

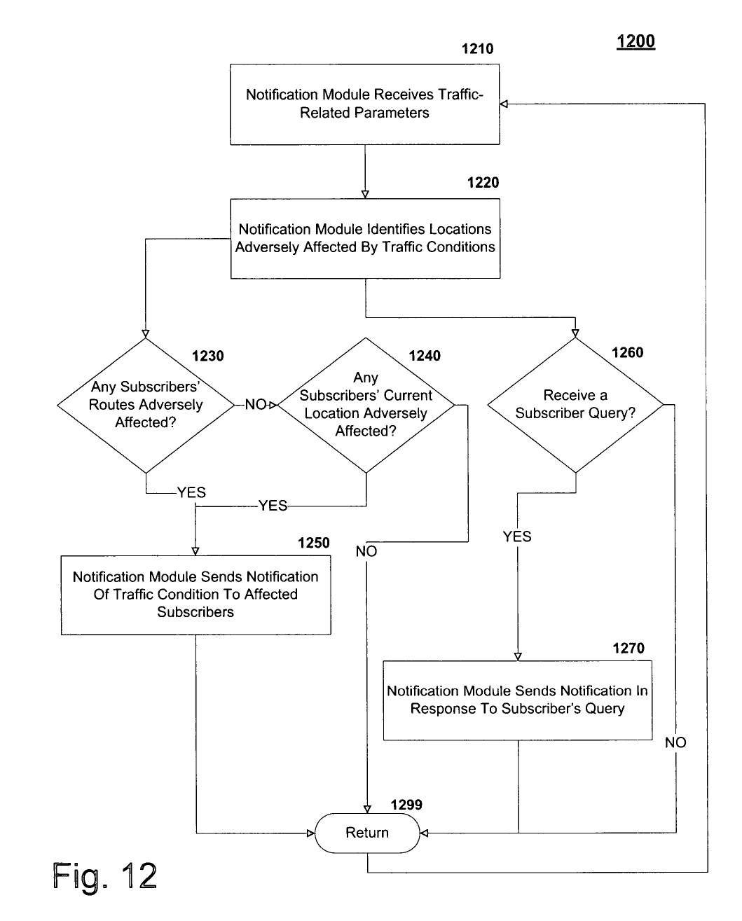

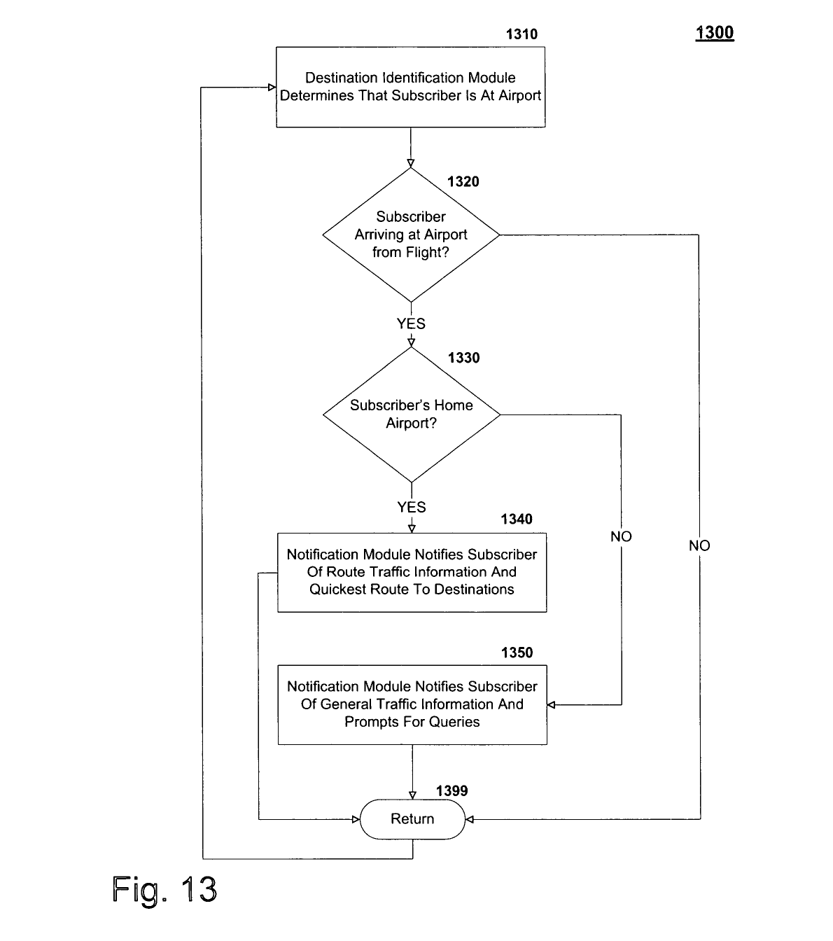

Additionally, when a subscriber travels to a different city, the consumer traffic monitoring and notification system 250, if active in that city, can detect when the subscriber is in the area, such as by the subscriber powering on her cellular phone handset, which registers with the network, or by otherwise notifying the consumer traffic monitoring and notification system 250. At that point, the subscriber will be able to receive notifications of congestion and incidents near the subscriber's location. When a subscriber lands at the airport in her home city, the consumer traffic monitoring and notification system 250 can send the subscriber travel times between the airport and “Work” or “Home,” or other Destination, allowing the user to pick the quickest route, or other general traffic information. This step is discussed in greater detail below, in connection with FIGS. 12 and 13.

FIG. 9 presents a process flow diagram 900 for tracking locations of a cellular phone user in accordance with an exemplary embodiment of the present invention. Referring to FIGS. 6 and 9, at step 910, the Data Extraction Module 160 extracts a set of signal data from a wireless carrier. This signal data includes cellular system transactions, such as initiated and terminated calls, registrations, and hand-offs for mobile stations. This extraction triggers the Tracking Module 610 to initiate.

At step 920, the Tracking Module 610 determines if any of the signal data corresponds to subscribers. In this step, the Tracking Module 610 would compare customer-identifying information, such as MDN, MSID, or ESN, associated with the signal data to the same customer-identifying information for subscribers, by accessing the customer-identifying information for subscribers stored in the Secure Subscriber Database 650.

At step 930, the Tracking Module 610 stores location information associated with the signal data into the Secure Subscriber Database 650. The location data may be the cell that the subscriber is in or may be more exact, based on global positioning system (GPS) information or other techniques for pinpointing the location of a cellular phone user. The Data Extraction Module 160 may determine the location based on the signal data and provide this location to the Tracking Module 610. In some cases, the Data Extraction Module 160 or Data Analysis Node 210 may further use the signal data and, in using the data, remove the customer-identifying information, such as by a Privacy Module 340 (see FIG. 3) performing the process 700 (see FIG. 7).

FIG. 10 presents a process flow diagram 1000 for identifying travel destinations for a user in accordance with an exemplary embodiment of the present invention. Referring to FIGS. 6, 9, and 10, at step 1010, the Destination Identification Module 620 accesses the Secure Subscriber Database 650 to identify new location records added to the database. In this exemplary embodiment, the records would be added at step 930 by the Tracking Module 610. At step 1020, the Destination Identification Module 620 determines the location associated with a subscriber's new record. In this step, the Destination Identification Module 620 associates a location and a time at that location with a subscriber. In an embodiment, the location is recorded in the Secure Subscriber Database 650 by the Tracking Module 610. In alternative embodiments, the Destination Identification Module 620 may determine the location based on other stored data.

At step 1030, the Destination Identification Module 620 determines if the location determined at step 1020 is in the subscriber's profile. This determination is made by looking up the subscriber's Destinations stored in the Secure Subscriber Database 650 and associated with the subscriber. If “YES,” the process 1000 returns to step 1020 to consider a new record for a different subscriber. As the purpose of process 1000 is to identify Destinations for a subscriber, the process 1000 may end if the location where the subscriber is at is already a defined Destination for that subscriber.

If the result of step 1030 is “NO,” the process 1000 moves to step 1040 and the Destination Identification Module 620 accesses the Secure Subscriber Database 650 to determine if the location identified at step 1020 represents a new location as compared to a recently stored location, that is, if the subscriber is moving. For example, the location determined at step 1020 may show the subscriber located near the corner of Peachtree Street and 14^{th} Street. A location associated with a time a few minutes prior to the time associated with the location identified in step 1020 may show the subscriber near the corner of Peachtree Street and North Avenue. In this example, the subscriber would be moving.

At step 1050, the Destination Identification Module 620 evaluates if the subscriber has changed locations. If “YES,” the process moves to step 1099 and returns to step 1020 to repeat the steps for a different subscriber. If the subscriber is moving, the location determined at step 1020 may not be a Destination. The Destination Identification Module 620 must evaluate additional time-stamped location data to determine if the location identified at step 1020 is a Destination. If “NO” (for example, the subscriber has been at the corner of Peachtree Street and 14^{th} Street and not moved since the previous location data was collected), the process 1000 moves to step 1060 and the Destination Identification Module 620 determines if the location determined at step 1020 has been marked as a “Potential Destination.” If “YES,” the Destination Identification Module 620 determines, at step 1070, whether to trigger a notification to the subscriber. This trigger may be based on whether the subscriber has been at the “Potential Destination” for a set period of time, such as an hour. This determination is based on information recorded in the Secure Subscriber Database 650, which can be used to determine the length of time the subscriber has been at the “Potential Destination.” At step 1080, the Destination Identification Module 620 notifies the subscriber that it has identified a “Potential Destination” and queries the subscriber if the subscriber wants to add the “Potential Destination” to her profile. A subscriber's profile includes, among other things, a listing of all Destinations associated with that subscriber.

If, at step 1060, the result is “NO,” the location determined at step 1020 is marked as a “Potential Destination” and stored the Secure Subscriber Database 650 at step 1090. Following either step 1080 or 1090, the process moves to step 1099 and returns to step 1020 to repeat the steps for a different subscriber.

The process 1000 may be run at set time intervals, such as every five minutes, or whenever the Tracking Module 610 updates the Secure Subscriber Database 650. One of ordinary skill in the art would appreciate that the process 1000 would be run for each subscriber as necessary, such as when a location associated with that subscriber has been added. Additionally, multiple instances of the process 1000 could simultaneously run, such as by instantiating a workflow that determines Destinations for each individual subscriber when the Secure Subscriber Database 650 has been updated with a record for that subscriber.

In short, the process 1000 identifies instances where the subscriber is stationary for a set period of time and allows the subscriber the opportunity to set that location as a Destination, for which the subscriber can receive traffic information. One of ordinary skill in the art will appreciate that other methods can be employed to set Destinations for a subscriber. In some cases, the subscriber can provide specific Destinations when establishing her subscription to the service. In other cases, the consumer traffic monitoring and notification system 250 (see FIG. 2) may have generic Destinations, such as “Turner Field” or “Fox Theater,” that any subscriber can access, such as in a query, “What is the quickest route from ‘Home’ to ‘Turner Field?’”

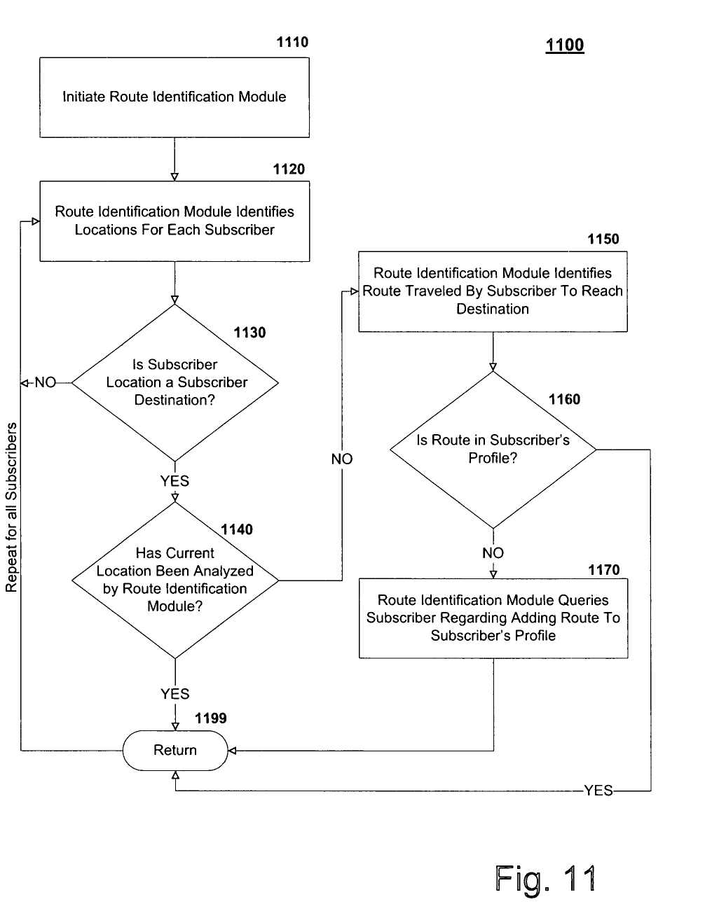

FIG. 11 presents a process flow diagram 1100 for identifying travel routes for a user in accordance with an exemplary embodiment of the present invention. Referring to FIGS. 6 and 11, at step 1110, the Route Identification Module 630 is initiated. At step 1120, the Route Identification Module 630 identifies the location of each subscriber. At step 1130, for one subscriber, the Route Identification Module 630 determines if the location for that subscriber is a Destination of that subscriber by accessing the subscriber's profile stored in the Secure Subscriber Database 650. If “NO,” the process 1100 returns to step 1120 and analyzes the next subscriber. The purpose of process 1100 is to identify routes that a subscriber takes between two Destinations. If the subscriber is not at a Destination, the process stops for that subscriber.

If the result of step 1130 is “YES,” the process 1100 moves to step 1140 and the Route Identification Module 630 determines if the current location has been analyzed by the Route Identification Module 630. In other words, has the subscriber been at this same location during a previous cycle of the Route Identification Module 630 just prior to this cycle, that is, a time close to the time for this cycle, and at that earlier time, the Route Identification Module 630 analyzed the route. For example, if the subscriber was at her Work Destination at 9:00 am and the Route Identification Module 630 performed a route analysis, and, at 9:30 am on that same day the subscriber is still at her Work Destination, then the Route Identification Module 630 would not analyze the route again. If “YES,” the process 1100 moves to step 1199 and returns to step 1120 to repeat the process for the next subscriber.

If “NO,” the process moves to step 1150, where the Route Identification Module 630 identifies the route traveled by the subscriber to reach the Destination identified at step 1130. In this step 1150, the route is determined by looking at location data stored in the Secure Subscriber Database 650 by the Tracking Module 610 for that subscriber leading to the Destination. The Route Identification Module 630 follows locations backwards in time until it identifies a starting Destination for the subscriber's trip.

At step 1160, the Route Identification Module 630 determines if the route identified at step 1150 is in the subscriber's profile. If “YES,” the process 1100 moves to step 1199 and returns to step 1120 to repeat the process for the next subscriber. If “NO,” the Route Identification Module 630 queries the subscriber regarding adding the route to the subscriber's profile. Then, the process 1100 moves to step 1199 and returns to step 1120 to repeat the process for the next subscriber.

FIG. 12 presents a process flow diagram 1200 for notifying a user of traffic information in accordance with an exemplary embodiment of the present invention. Referring to FIGS. 6 and 12, at step 1210, the Notification Module 640 receives traffic-related parameters. These parameters may include traffic speeds along specific road segments or routes; incidents, such as accidents or road work; events, or weather, such as ice on a roadway or a thunderstorm. These traffic-related parameters may come from a cellular-based traffic information system, other information systems, or a combination of both.

At step 1220, the Notification Module 640 identifies locations adversely affected by traffic conditions, based on the traffic-related parameters received at step 1210. At step 1230, the Notification Module 640 determines of any subscribers' routes are adversely affected by the traffic conditions. If “YES,” the process 1200 moves to step 1250 and the Notification Module 640 sends a notification of the traffic condition to affected subscribers. The notification may be that there is an accident on I-75 north at Mt. Paran Road or might indicate that the expected travel time from a subscriber's “Work” Destination to “Home” Destination is 50 minutes. This latter notification may be based on preferences set by the subscriber and the subscriber's current location. The preference may be “Notify me if the travel time from Work to Home exceeds the normal travel time by 20 minutes, it is past 5:00 pm, and I am currently at Work.” Notifications would be sent to all affected subscribers.

If the result at step 1230 is “NO,” the process 1200 moves to step 1240 and the Notification Module 640 determines if any subscribers' current location is adversely affected by the travel condition. If “YES,” the process 1200 moves to step 1250 and the Notification Module 640 sends a notification of the traffic condition to affected subscribers. For example, if the subscriber is located at the intersection of U.S. Highway 41 and Akers Mill Road and an incident occurs within a certain radius of that location, then the Notification Module 640 would notify the subscriber of the incident. Notifications would be sent to all affected subscribers. Following step 1250, process 1200 moves to step 1299 and returns to step 1210 and awaits receipt of further traffic-related parameters.

If the result at step 1240 is “NO,” the process moves to step 1299 and returns to step 1210 and awaits receipt of further traffic-related parameters.

One of ordinary skill in the art would appreciate that the notifications sent at step 1250 are passive as to the subscriber—the Notification Module 640 automatically sends the notification without any actions necessary by the subscriber, at least at the time of the notification (the subscriber may have set up certain notifications as part of that subscriber's profile). In another scenario, the subscriber may send a query to the Notification Module 640 to determine traffic conditions. At step 1260, which also flows from step 1220, the Notification Module 640 determines if it has received any queries from subscribers. If “YES,” the Notification Module 640 moves to step 1270 and sends a notification in response to the queries. For example, a subscriber may query the system of the quickest route from its current location, which may or may not be a Destination for that subscriber, and a subscriber-specific Destination, such as Home (or perhaps other location, such as a system Destination or an address). If the result at step 1260 is “NO,” the process moves to step 1299 and returns to step 1210 and awaits receipt of further traffic-related parameters.

FIG. 13 presents a process flow diagram 1300 for notifying a user of traffic information based on the user being located at an airport in accordance with an exemplary embodiment of the present invention. Referring to FIGS. 6 and 13, at step 1310, the Destination Identification Module 620 determines that a subscriber is at a local airport. At step 1320, the Destination Identification Module 620 determines if the subscriber is arriving at the airport from another location in that city, such as when the subscriber is preparing to leave on a trip, or if the subscriber is arriving at the airport from an inbound flight. If the result at step 1320 is “YES,” the process 1300 moves to step 1330 and the Destination Identification Module 620 determines if the airport is the subscriber's “home” airport, that is, the airport for the city in which the subscriber lives, at step 1330. If the result of step 1320 is “NO,” the process 1300 moves to step 1399 and returns to step 1310 to repeat the steps for a different subscriber when an indication that a different subscriber has arrived at the airport.

If the result of step 1330 is “YES,” the process 1300 moves to step 1340 and the Notification Module 640 notifies the subscriber of route traffic information and the quickest route to destinations. For example, the Notification Module 640 may indicate the quickest route to the subscriber's “Home” or “Work” and that I-285 N has an accident.

If the result of step 1330 is “NO,” the process 1300 moves to step 1350 and the Notification Module 640 notifies the subscriber of general traffic information, such as the travel time from the airport to the downtown area or traffic incidents. The Notification Module 640 may also prompts the subscriber for a query, such as the quickest route to a specific hotel. At this step, the Notification Module 640 determines that the subscriber is traveling in that city and tailors the information to a traveler. The Notification Module 640 would recognize that the subscriber has no Destinations for that city. Of course, the city may be a frequent travel area for the subscriber, such as a branch office or relative's location, and the subscriber may have specific Destinations for that location.

One of ordinary skill in the art would appreciate that another default location, other than an airport, may be used for the process 1300.

In view of the foregoing, one would appreciate that the present invention supports systems and methods for actively providing consumer traffic monitoring and notification. The present invention determines a user's location, based on the location of the user's cellular phone. The present invention may determine specific destinations that the user often travels to and from and routes that the user takes between destinations. The present invention may inform the user of traffic conditions based on information received by or developed by the system. These notifications may be actively sent to the user based on the user's location or the user may query the system for information. The system may automatically deliver information to the user based on specific locations of the user, such as arriving at an airport from another city.

What is claimed is:

1. A system for providing consumer traffic monitoring and notification comprising:
a data extraction module operable to extract signal data from a wireless telephony network comprising location information for a mobile station;
a data analysis node, logically connected to the data extraction module and operable to identify a location associated with the mobile station, receive traffic-related information, and automatically send a notification in response to the location of the mobile station and the received traffic-related information;
a destination identification module logically connected to the data analysis node and operable to determine a destination associated with the mobile station based on identified locations for the mobile station; and
a route identification module, logically connected to the destination identification module and operable to determine one or more routes between the mobile station and one or more destinations.

2. The system of claim 1 wherein the data analysis node is further operable to respond to a query related to traffic conditions from the user of the mobile station.

3. The system of claim 1 further comprising a secure database comprising determined destinations and routes.

4. The system of claim 1 wherein the data analysis node is operable to send the notification to the mobile station.

5. The system of claim 1 wherein the data analysis node is further operable to automatically send a notification comprising traffic conditions in response to the mobile station location comprising a pre-established location.

6. The system of claim 5 wherein the pre-established location is an airport.

7. A method for providing consumer traffic monitoring and notification comprising the steps of:
determining a plurality of locations of a mobile station, based on signal data from a wireless telephony network;
determining a plurality of destinations for the mobile station based on the determined plurality of locations;
determining a route between one of the plurality of locations of the mobile station and any of the plurality of the determined destinations for the mobile station;
receiving traffic-related information; and
automatically sending a notification in response to the received traffic-related information; wherein the notification comprises traffic conditions associated with the route.

8. The method of claim 7 wherein the step of determining a route between any two of the determined destinations comprises the steps of:
determining that the mobile station is at a first determined location;
identifying a determined destination comprising one of the plurality of determined destinations;
identifying a plurality of locations of the mobile station as the mobile station traveled between the first determined destination and the second determined destination during a single trip to the first determined destination; and
defining a travel route for the mobile station based on the identified plurality of locations.

9. The method of claim 7 further comprising the steps of:
allowing a user of the mobile station to confirm the determined destinations; and
storing confirmed destinations in a secure database.

10. The method of claim 7 further comprising the steps of:
allowing a user of the mobile station to confirm the determined routes; and
storing confirmed routes in a secure database.

11. The method of claim 7 further comprising the steps of:
receiving from a user of the mobile station a request to receive traffic information related to a determined route; and
sending a notification in response to the request.

12. A method for providing consumer traffic monitoring and notification comprising the steps of:
determining a location of a mobile station;
determining whether the location of the mobile station corresponds to a pre-existing location;
receiving traffic-related information; and
automatically sending a notification in response to the received traffic-related information when the location of the mobile station corresponds to the pre-existing location; wherein the notification comprises traffic conditions associated with the pre-existing location.

13. The method of claim 12 wherein the pre-existing location comprises an airport.

14. The method of claim 12 wherein the notification comprises the quickest route between the pre-existing location and a destination.

15. A system for providing consumer traffic monitoring and notification comprising:
a data extraction module operable to extract signal data from a wireless telephony network comprising location information for a mobile station; and
a data analysis node, logically connected to the data extraction module and operable to identify a location associated with the mobile station, receive traffic-related information, and automatically send a notification in response to the location of the mobile station and the received traffic-related information.

16. The system of claim 15 further comprising a destination identification module logically connected to the data analysis node and operable to determine a destination associated with the mobile station based on identified locations for the mobile station.

17. The system of claim 16 further comprising a route identification module, logically connected to the destination identification module and operable to determine one or more routes between the mobile station and one or more destinations.

18. The system of claim 15 wherein the data analysis node is further operable to respond to a query related to traffic conditions from the user of the mobile station.

19. The system of claim 15 further comprising a secure database comprising determined destinations and routes.

20. The system of claim 15 wherein the data analysis node is operable to send the notification to the mobile station.

21. The system of claim 15 wherein the data analysis node is further operable to automatically send a notification comprising traffic conditions in response to the mobile station location comprising a pre-established location.

22. The system of claim 21 wherein the pre-established location is an airport.
